(19) United States
(12) Patent Application Publication
(10) Pub. No.: US 2019/0333108 A1
(43) Pub. Date: Oct. 31, 2019

(54) METHOD FOR DELIVERING TAILORED CONTENT TO TRANSPORTATION NETWORK COMPANY PASSENGERS

(71) Applicant: Gidget D. Black, Woodstock, GA (US)

(72) Inventor: Gidget D. Black, Woodstock, GA (US)

(21) Appl. No.: 16/391,637

(22) Filed: Apr. 23, 2019

Related U.S. Application Data
(60) Provisional application No. 62/664,509, filed on Apr. 30, 2018.

(51) Int. Cl. G06Q 30/02

(52) U.S. Cl. CPC G06Q 30/0265; G06Q 30/0277

(57) ABSTRACT

A computer implemented method for selectively delivering content to transportation network company passengers is provided. The method embodies a systemic software application adapted to acquire travel data from the transportation network company platform so as to utilize such data, at least in part, to selectively determine and deliver audio and video content to the transportation network company passenger associated with the respective travel data by way of a content database/server.

### CROSS-REFERENCE TO RELATED APPLICATION

This application claims the benefit of priority of U.S. provisional application No. 62/664,509, filed 30, Apr. 2018, the contents of which are herein incorporated by reference.

### BACKGROUND OF THE INVENTION

The present invention relates to a content delivery systems application and, more particularly, to a method for delivering advertising and marketing content to transportation network company passengers, wherein the software application owner will profit from advertising, and, to a more limited extent the transportation network company driver will profit, from the software application using limited generalized passenger travel data such as age, gender, and travel route data provided by the driver-side interface of a transportation network company platform. The advertising and marketing content delivery services will contain content from local and national businesses that will target the transportation network company passenger based on the aforementioned generalized passenger data.

A transportation network company (TNC), sometimes known as a ride-sharing service or ride-hailing service, such as Uber™ and Lyft™, is a company that matches passengers and drivers via online TNC platforms, such as mobile software applications (“apps”), that provide a TNC passenger-interface for choosing a pickup location and drop off destination as well as obtaining quotes and information about the TNC driver and TNC vehicle and a TNC driver-side interface that also contains the travel data regarding pickup location and drop off destination.

The driver/owner/operator of a TNC vehicle currently does not have a method to obtain marketing revenue from their passengers, nor do local and national businesses have a readily available method to advertise to passengers in TNC vehicles, who are a captive audience for extended durations of time, and for whom, unlike Joe Public, there is known data associated with each passenger—i.e., where they are coming from and where they are going.

Currently there is no readily-available methodology for delivering advertising or marketing content in a TNC driver's vehicle and based in part on data from the TNC interface so that the content may be tailored for the TNC passenger based on their age, gender, pickup location, and drop-off destination, and the like. The TNC driver will have the ability to opt-out of certain advertising or marketing content that they do not agree with. Such selectiveness also affords the TNC driver control of the content delivered, which they may not otherwise agree with ethically or morally. Also, there are no current content delivery services that enable the TNC driver to obtain compensation for marketing in their own vehicles.

As can be seen, there is a need for a method for selectively delivering content to transportation network company passengers, wherein the transportation network company driver, the software application owner, and local and national businesses may profit from coupling information obtained from the transportation network company travel data about their passengers with content from local and national businesses advertising content.

This application, or “app,” for any smart phone or tablet, would make possible a method for a smart device to interact with any compatible display screen, intrinsically or independently, such as using the app on a larger smart-tablet screen, or via blue-tooth or wired connectivity to built-in headrest monitors, for displaying the selected content to the TNC passengers. The present invention also provides more accessibility to a direct marketing platform/database/server for local and national businesses to consumers, and cost-effective accessibility for potential reimbursement for the TNC drivers.

The software application may be adapted to interface with the driver-side of the TNC platform so as to ascertain limited passenger data such as age, gender, and pickup location and drop off destination data, and utilize such data in the selection of the content delivered.

The software application embodied by the present invention allows TNC operators to obtain revenue for advertising within their vehicle and opt-out of any disagreeable content, while giving an advertising and marketing platform to small and large corporations to market directly to a captive audience in a TNC vehicle.

### SUMMARY OF THE INVENTION

In one aspect of the present invention, a computer-implemented method for selectively delivering content to transportation network company passengers includes delivering audio and video content to a transportation network company vehicle, wherein a transportation network company driver streams the audio and video content to the transportation network company passenger, while having the ability to opt-out of content that does not align with the driver's moral and ethical standards.

In another aspect of the present invention, the computer-implemented method for selectively delivering content to transportation network company passengers includes the following: loading a software application on a first computer associated with a transportation network company driver, wherein the software application is configured to access a plurality of audio and video content retrievably stored on a content database/server; and providing a user interface operatively associated with the first computer for providing and displaying the plurality of audio and video content to the transportation network company passengers, wherein the first computer is operatively associated with a transportation network company driver-side interface containing travel data associated with each transportation network company passenger, and wherein the software application is configured to selectively access one or more audio and video content from the plurality of audio and video content based, at least in part, on the travel data. The local and national businesses using the advertising platform within the server will be able to upload their content to the database/server which will, in-turn, use the passenger data for the purpose of providing relevant content based on age, gender, and travel route.

These and other features, aspects and advantages of the present invention will become better understood with reference to the following drawings, description and claims.

### BRIEF DESCRIPTION OF THE DRAWINGS

FIG. 1 is a flowchart view of an exemplary embodiment of the present invention; and

FIG. 2 is a continuation of FIG. 1′s flowchart view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a computer implemented method for selectively delivering content to transportation network company passengers, wherein limited passenger data such as age, gender, and travel data from the transportation network company platform is accessed by the systemic software application so as to be utilized, at least in part, to selectively determine and deliver audio and video content to the transportation network company passenger associated with the respective travel data. Thus, the computer implemented method solves an inherently computer/internet-based problem—utilizing transportation network company passenger data that is created and utilized electronically prior to being reduced to paper, and integrating it in a practical application of delivering content tailored to the associated transportation network company passenger.

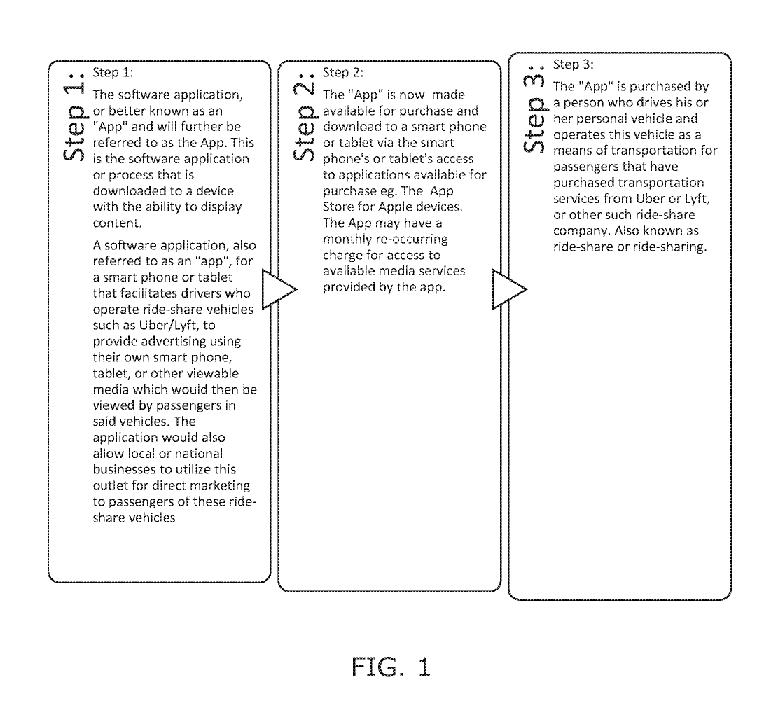

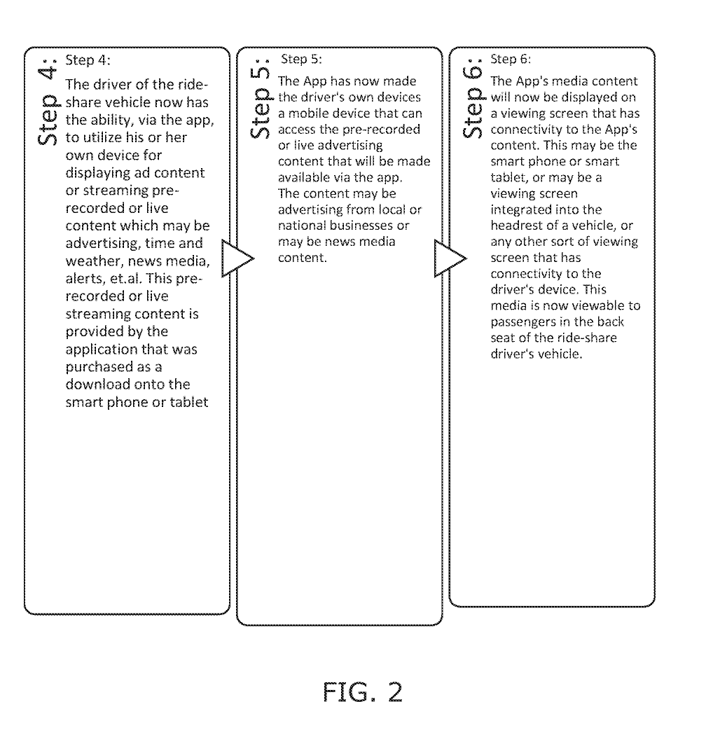

Referring to FIGS. 1 and 2, the present invention may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The software application loaded on the computer is adapted to access a content database/server retrievably storing a plurality of audio and video content, wherein the computer's user interface provides a display screen for displaying said audio and video content. The software application may also be coupled to the TNC platform associated with the TNC vehicle so as to export travel data regarding pickup location and drop off destination information associated with each TNC passenger. Such travel data may be supplied to the content database/server, via the software application, so that each of the plurality of audio and video content is selectively retrieved base, at least in part, on the travel data.

The content may include advertising content, pre-recorded or live, weather, news media, alerts, etc. The content may be advertising from local or national businesses or may be news media content. In certain embodiments, the viewing screen may be integrated into the headrest of a vehicle, or any other sort of viewing screen that has connectivity to the driver's smart device loaded with both the systemic software application and driver-side interface of the TNC platform, thereby making the content viewable to passengers in the back seat of the ride-share driver's vehicle.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-implemented method for selectively delivering content to transportation network company passengers, comprising:
delivering audio and video content to a transportation network company vehicle, wherein a transportation network company driver is enabled to selectively opt-out of the audio and video content.

2. The computer-implemented method of claim 1, wherein the audio and video content comprise advertisement.

3. A computer-implemented method for selectively delivering content to transportation network company passengers, comprising:
loading a software application on a first computer associated with a transportation network company driver, wherein the software application is configured to access a plurality of audio and video content retrievably stored on a content database/server; and
providing a user interface operatively associated with the first computer for providing and displaying the plurality of audio and video content to the transportation network company passengers,
wherein the first computer is operatively associated with a transportation network company driver-side interface containing travel data associated with each transportation network company passenger, and wherein the software application is configured to selectively access one or more audio and video content from the plurality of audio and video content based, at least in part, on the travel data.

4. The method of claim 3, wherein the travel data comprise pickup location and drop off destination associated with each transportation network company passenger.

5. The computer-implemented method of claim 4, wherein each audio and video content comprise advertisement.
